(19) United States
(12) Patent Application Publication
(10) Pub. No.: US 2007/0198298 A1
(43) Pub. Date: Aug. 23, 2007

(54) System and methods for automated payment for health care services utilizing health savings accounts

(75) Inventor: Lynn E. Carroll, Jacksonville, FL (US)

Correspondence Address: HOGAN & HARTSON LLP;IP GROUP, COLUMBIA SQUARE, 555 THIRTEENTH STREET, N.W., WASHINGTON, DC, 20004, US

(73) Assignee: Payformance Corporation

(21) Appl. No.: 11/648,900

(22) Filed: Jan. 3, 2007

Related U.S. Application Data
(60) Provisional application No. 60/754,892, filed on Dec. 30, 2005.

(51) Int. Cl. G06Q 10/00; G06Q 40/00

(52) U.S. Cl. 705/2; 705/4

(57) ABSTRACT

The invention provides a system and method for the automated payment of health care costs. The invention facilitates the payment to health care provider of amounts owed by a patient and amounts owed by the health insurance company in a single automated transaction.

### CROSS REFERENCE TO RELATED APPLICATION

This application claims priority under 35 U.S.C. §119 to U.S. Provisional Application No. 60/754,892, filed Dec. 30, 2005, the disclosure of which is incorporated herein by reference.

### BACKGROUND OF THE INVENTION

1. Field of the Invention

The invention relates to a system and method for automated payments to health care providers, and more particularly to a system and method that facilitates payment of both patient responsible amounts and insurance company responsible amounts to a health care provider in a single transaction.

2. Description of Related Art

Payment for health care services has typically been a time and paper intensive process. Typically, a patient will arrive at the health care facility and present identification and/or proof of insurance. The health care service is provided and then the patient is notified of a patient-responsible amount of payment, i.e., amount that is not covered by the patient's insurance coverage (deductible). This amount may be predetermined or fixed based upon rates that were pre-negotiated by the insurance carrier. However, this amount may not be the amount ultimately owed by the patient since the exact patient-responsible amount has not yet been adjudicated by the insurance carrier. Thus, at the point of service, the patient will make payment based upon what the health care provider believes is owed by the patient. However, this amount may change once the claim is adjudicated by the insurance carrier. For example, the insurance carrier may determine that a certain service was provided outside of the prenegotiated parameters and, therefore, the patient responsible amount is greater than what was billed to the patient at the point of service. In such cases, the patient will be notified that of the additional amount due.

At the point of service, the patient will typically make payment in the form of cash, check, credit card or debit card. In some cases, the health care provider may not be equipped to accept payment by credit or debit card. Payments made later in time are also typically made by check, credit card or debit card.

As a result of recent legislation by the Federal government, payments by the patient may also be made through a health savings account (HSA). An HSA is a tax-favored account created by the 2003 Medicare prescription drug law for certain eligible individuals covered under certain high-deductible health insurance plans (HDHP) for covering current and future medical expenses. The premium for a HDHP generally is less than the premium for traditional health care coverage. Money saved on insurance premiums might be put into the Health Savings Account, or employed for other purposes. The HSA is opened, owned and funded by the individual insured under the HDHP. In some cases, the HSA may also be funded by an employer. Employee contributions to the HSA are tax deductible while employer contributions are contributions are deductible to the business. Any distributions from an HSA are tax free if they are used to pay qualified medical expenses.

As was described above, once a health care service has been delivered and the patient has made payment on what it is believed he or she owes, the health care provider presents the remaining balance to the insurance carrier for adjudication. In many cases, the insurance carrier will determine that the patient owes more than he or she paid at the time the health care service was provided. In these instances, the patient must be contacted and instructed that additional payment must be made to the health care provider. If the patient wants the additional payment to be deducted from a HSA or other tax advantages account, then these payments must be ‘substantiated.’ This means that they must be a legitimate qualifying expense as defined by the HSA plan. In addition, the patient-responsible amounts should match the amount for which the patient is responsible as reported on the adjudicated claim remittance by the insurance carrier. Ensuring that these two considerations are met can consume additional time and resources.

The conventional payment methodologies as described can require substantial time and paperwork to implement and, in particular, excessive time may be required for delivering and processing physical documents, as well as overhead costs involved with delivering physical documents, such as the cost of postage or a private delivery service and the personnel necessary to administer the handling of such documents. These conventional billing and payment methods are also cumbersome due to the need for complex record keeping and the need to store large quantities of paper records. These issues are exacerbated when patients seek to make payment of patient-responsible amounts through an HSA. Thus, an improved system and method for making payments from an HSA to health care providers is desirable.

### SUMMARY OF THE INVENTION

The invention provides a system and methods that facilitate full payment for health care services in a single payment transaction. The invention provides a consumer-directed health care (CDHC) system that coordinates payments from a consumer's HSA account directly to an insurance company for those amounts that are a health care consumer's responsibility. In accordance with the invention, the insurance company first adjudicates the claim for payment submitted by the health care provider. Then, full payment of the adjudicated claim is made from the insurance company's account, so that full payment to the health care provider is made in a single transaction. The insurance company notifies the CDHC of the payment amount that is the consumer's responsibility. The CDHC then initiates the transfer of the consumer responsible payment from the consumer's HSA to the insurance company's account. In this manner, the entire claim from the health care provider is satisfied in a single transaction, while still enabling a consumer to utilize his or her HSA in order to pay for any consumer responsible amounts. In the event that the HSA does not sufficient funds to cover the consumer responsible amount, the consumer is notified of the deficiency and can made arrangements for payment using another payment mechanism. In accordance with one embodiment of the invention, the consumer can register several alternate accounts with the CDHC that can be utilized in the event that the primary HSA account has insufficient funds to cover payment.

The invention provides numerous advantages over the conventional payment methodologies, including more rapid disbursement of payment; customized delivery of payment and associated information; simplified accounting, record keeping, and management of payment; a reduction in administrative and operating costs; improved fraud detection; and fewer processing errors as a result of a more uniform approach to information presentation and handling.

Accordingly, the invention allows for payments for high-deductible plans that include an HSA to reach the health care provider from a single source and in the same remittance format the health care provider would typically receive payments from the insurance company. The process in accordance with the invention also eliminates problems with substantiation and use of credit and/or debit cards. In this manner the payment process is simplified allowing the health provider to focus its resources on the delivery of high quality health care.

Thus, one aspect of the invention is to provide a system that facilitates automated payment for health care services in a single transaction.

Another aspect of the invention is to provide a system that facilitates the automatic deduction of consumer responsible health care costs from a consumer's HSA into an insurance company's account in order to reimburse the insurance company for payments made to a health care provider.

Another aspect of the invention is to provide a system that allows a consumer to establish business rules that create a hierarchy of consumer accounts from which consumer responsible health care costs may be deducted.

Another aspect of the invention is to provide a methodology for payment of adjudicated health care claims in a single transaction using a consumer's HSA.

### BRIEF DESCRIPTION OF THE DRAWINGS

FIG. 1 is a block diagram of a system in accordance with an embodiment of the invention for facilitating the automated payment for health care services; and

FIG. 2 shows a flowchart illustrating a process through which payments for health care services are made in accordance with an embodiment of the invention.

### DETAILED DESCRIPTION OF THE PREFERRED EMBODIMENTS

The invention disclosed herein may be beneficially applied to diverse business entities across numerous service industries, such as the health care industry and insurance industries.

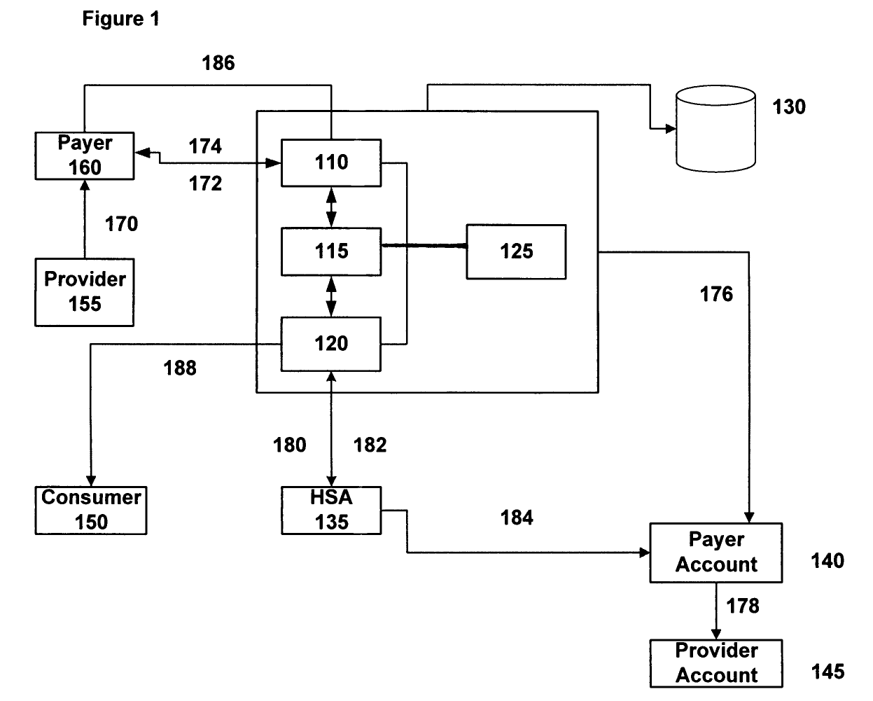

FIG. 1 illustrates a block diagram of a system for payment of health care services in accordance with an embodiment of the invention. FIG. 1 shows a CDHC server 105 which facilitates the automated payment and reconciliation of health care costs. The CDHC server 105 also includes a file processing application 110, a business rules engine 115, a file validation application 120 and a consumer decisioning and provider matching application 125. The file processing application 110 receives and processes the payment request. The business rules engine 115 contains various rules that govern how and where payments are made. The file validation application 120 assures that the payment file meets the requirements for payment. The consumer decisioning and provider matching application 125 facilitates payments to the health care provider and to the insurance company for any consumer responsible amounts by making sure that payments are made to and from the correct accounts. The CDHC server 105 is coupled to a claim archive and payment database 130. The claim archive and payment database 130 provides a record of all past payments and adjudicated claims submitted for payment along information about the insurance company's account, the health care provider's account and the consumer's HSA. Such information may include the name of the financial institution holding the account, the name of the account holder and the account number.

FIG. 1 also shows several bank accounts: a consumer HSA account 135, a payer (for example, an insurance company) account 140, a provider account (for example, a health care provider) 145. The payer account 140 is the account from and to which funds are transferred for payments and reimbursements. The HSA account 135 can be accessed in order to pay for any consumer responsible amounts. The provider account 145 receives payment for services rendered by the provider. As shown in FIG. 1, in one embodiment of the invention, the provider account 145, the payer account 140, the CDHC server 105 and the HSA account 135 may all be communicatively coupled via an electronic network, such as through the Internet. Also, it should be understood that the payer account 140 may be a third party insurance administrator acting in the same role of payer as an insurance company. For example, certain self-insured organizations may employ third party administrators to carry out the administrative functions to manage the self-insured organization's health care system, including working with health care providers and health care consumers.

FIG. 1 also shows a health care consumer (patient) 150, a health care provider 155 and a payer 160. It should be understood that the consumer 150 may be any individual seeking health care services. The provider 155 may be an entity capable of providing health care services and which most likely generates a bill for its services rendered such as a physician, hospital or pharmacy. The payer 160 may be any third party capable of making payment for the health care service, including an insurance company.

In operation, the consumer 150 goes to the health care provider 155 seeking health care services. The consumer 150 may be queried as to his or her identity and/or insurance coverage. Then, the health care service is rendered. Once the health care service is rendered, the health care provider 155 presents the payer (insurance company) 160 with a claim for payment 170 based upon the services rendered to the consumer. The insurance company 160 adjudicates the claim 170 and makes a determination of what portion of the payment is the responsibility of the consumer 150. Once the claim 170 is adjudicated, the insurance company 160 also generates a payment request 172 that is sent to the CDHC server 105 for processing. The received payment request 172 is first received by the file preprocessing application 110. The file preprocessing application 110 makes sure that the payment request 172 contains adequate information and is in a proper format so that payment can be made. The payment request 172 is then processed by the business rules application 115. The business rules engine 115 contains various rules governing payment, including the requirements for payment to be made, as well as various conditions for payment that may have been requested by the payer 105 or the provider 155. These conditions may include rules on when and how payments are to be made as well as rules relating to how consumer responsible amounts should be handled. The payment request 172 is then received by the file validation application 120 for further processing. The file validation engine 120 sends notification 174 to the payer acknowledging that the payment request has been received and that payment will be made. The payment request 172 is then forwarded to the consumer decisioning and provider matching application 125. The consumer decisioning and provider matching application 125 generates an instruction for payment 176 which includes specific detail relating to which account the payer 160 has requested be used for payment to the provider. The consumer decisioning and provider matching application 125 also matches the received request for payment with the provider who rendered the health care service. Thus, the instruction for payment 176 is directed to the payer account 140 to make payment. The account 140 generates an electronic payment 178 that draws funds from an payer's account. This electronic payment 178 is a payment of the entire adjudicated amount and includes both the consumer responsible amount and the insurance company responsible amount. This payment 178 is made to the health care provider account 145 as one consolidated payment in satisfaction of the claim.

In order to account for any portion of the payment 178 that is the responsibility of the consumer 150, the CDHC server 105 application first notifies the consumer 150 that a consumer responsible amount 188 is due and also formats a reimbursement instruction 180 to the consumer's HSA 135. This reimbursement instruction 180 withdraws the consumer responsible amount from the HSA 135 as an electronic funds transfer from the HSA 135 to the to the payer account 140. A reimbursement confirmation 186 is sent to the payer 160 providing notification that the payer 160 has now been reimbursed for paying the consumer responsible amount to the provider 155. The HSA 135 also sends a confirmation of the transfer of funds 182 to the CDHC server 105. In this manner, the payer account 140 is reimbursed for making payment of the consumer responsible amount to the health care provider account 145.

In an alternate embodiment of the invention, the CDHC server 105 queries the consumer 150 as to whether the consumer 150 would like payment of the consumer responsible amount to come from the HSA 135 or from an alternative form of payment as selected by the consumer. In this embodiment of invention, the consumer can establish a hierarchy of accounts from which funds can be withdrawn for reimbursement of consumer responsible amounts. In this embodiment, for example, the primary account may be an HSA, while the secondary account may be a checking account and the third account may be a credit account. These consumer preferences can be established in the business rules of the CDHC server 105, so that the system know which accounts have been selected by the consumer 150 for payment of the consumer responsible amounts.

In the event that the HSA 135 does not have adequate funds to cover the consumer responsible charges, the payer 160 is notified and a request for payment 188 to the consumer 150 is made. The consumer 150 then makes a payment or payments that reimburse the payer 160 for the consumer responsible amount that balance it is due having paid the full adjudicated claim.

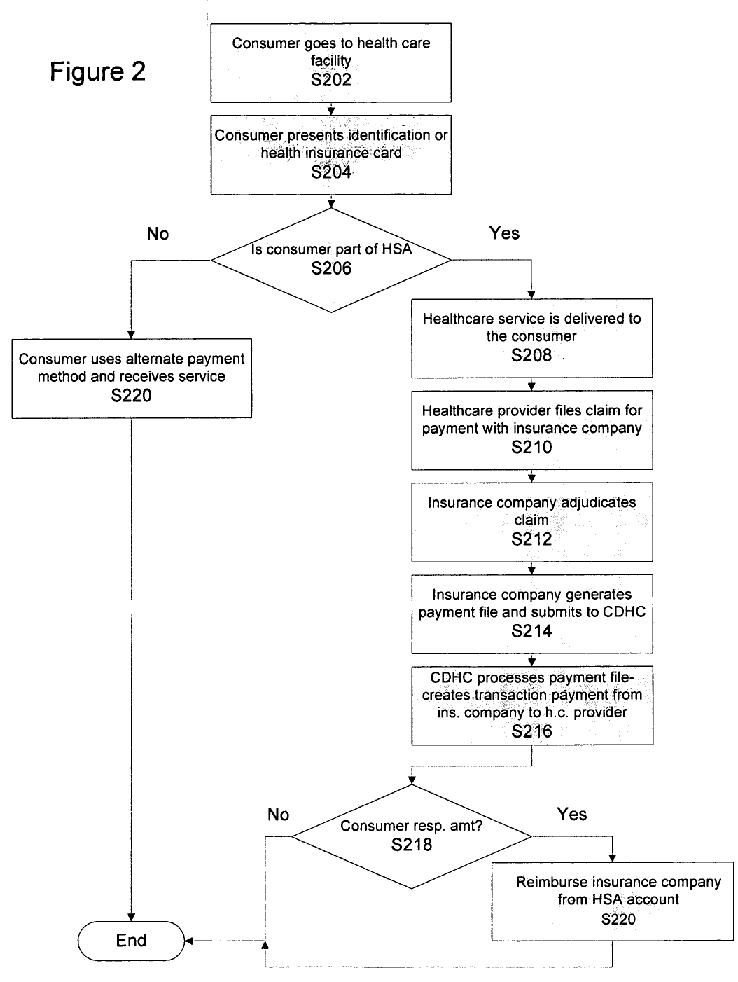

FIG. 2 illustrates the process for facilitating payments for health care services in accordance with an embodiment of the invention. In FIG. 2, the process begins with step S202 where a consumer is present at the health care facility (point of service). The process then moves to step S204 where the consumer presents identification and/or a health insurance card to the health care provider. The process then moves to step S206. In step S206, the heath care provider determines whether the consumer is a member of a high-deductible plan with a health savings account (HSA). If the consumer is not a member of a HSA, the process moves to step S220 where the consumer makes payment via some a conventional mechanism either before or after receiving the health care service depending upon the requirements of the health care provider and the process then ends. Alternatively, if the consumer is a member of a HSA, the process moves to step S208 where the health care services are delivered to the consumer. At this point, the consumer does not make any payment for the services rendered. Alternatively, is a nominal co-payment is required at this point, the consumer can make such payment using any payment method, including but not limited to a debit card that is coupled to the consumer's HSA which automatically deducts payment from such account

The process then moves to step S210. In step S210, the health care provider files a claim for payment with the insurance company. The process then moves to step S212, where the insurance company adjudicates the claim for payment and determines a consumer responsible amount in accordance with the insurance plan. Thus, in this step, the insurance company determines how much, if any, of the payment is owed by the consumer as opposed to the insurance company based upon the insurance plan deductible as well as any terms and conditions that may have been pre-negotiated between the consumer, insurance company and/or health care provider.

The process then moves to step S214 where the insurance company generates a payment file, which is submitted to the consumer-directed health care (CDHC) system in accordance with the invention. The process then moves to step S216. In step S216, the CDHC system processes the payment file and creates an electronic payment transaction from the insurance company's bank account to the health care provider's bank account in the full amount owed by the consumer. This includes any consumer responsible amount and the insurance company responsible amount. The CDHC thus initiates an electronic funds transfer that accesses the insurance company's bank account in order to transfer funds to the health care provider's bank account. The process then moves to step S118, where the system determines whether there is consumer responsible amount that was paid by the payer. If there is no consumer responsible amount, the process then ends. If in step S118 the system determines that there is a consumer responsible amount, the process moves to step S120 where the CDHC formats a reimbursement instruction to a bank that is the custodian of the consumer's HSA. This reimbursement instruction transfers the amount of funds that are the responsibility of the consumer (i.e., the deductible or co-payment) from the consumer's HSA into the insurance company's bank account. Thus, the insurance company's bank account is reimbursed for making the consumer responsible payment to the health care provider. In the event that the HSA does not have adequate funds to cover the consumer responsible payment, the consumer is notified of this deficiency of funds in the HSA and is requested to pay any outstanding balance to the insurance company. The process then ends. At this point, the health care provider has been fully paid, the insurance company has paid the amount it is due to reimburse under the guidelines of the insurance policy and the consumer has paid whatever portion he or she is responsible for.

The foregoing description of the preferred embodiments of the invention has been presented for the purposes of illustration and description. It is not intended to be exhaustive or to limit the invention to the precise form disclosed. Many modifications and variations are possible in light of the above teaching.

What is claimed:

1. A method for facilitating payment to a health care provider, comprising the steps of:
receiving an adjudicate claim for payment, the adjudicated claim for payment including a consumer responsible portion and an payer responsible portion;
directing a request for payment of the adjudicated claim to a centralized payment application;
causing payment to be made to the health care provider for the entire adjudicated claim; and
generating at least one request for reimbursement based upon the consumer responsible amount.

2. The method according to claim 1, wherein adjudicated claim, the consumer responsible portion and the payer responsible portion is determined by an insurance company.

3. The method according to claim 1, wherein the centralized payment application includes business rules governing payment of the adjudicated claim, the business rules including at least one of a payer's account information and payment preferences, a payee's account information and payment preferences and a consumer's account information and payment preferences.

4. The method according to claim 1, wherein the payer is an insurance company.

5. The method according to claim 1, wherein the payment is withdrawn from an insurance company's account and directed to a health care provider's account.

6. The method according to claim 1, wherein the request for reimbursement is sent to a consumer's designated payer.

7. The method according to claim 5, wherein the consumer's designated payer is a health savings account (HSA).

8. The method according to claim 6, wherein the request for reimbursement results in payment of the consumer responsible amount from the HSA to the payer's account.

9. The method according to claim 1, further including the step of notifying the payer upon reimbursement.

10. The method according to claim 1, further including the step of notifying the consumer if the HSA account has insufficient funds to cover the request for reimbursement.

11. A system for facilitating payments to a health care provider, comprising:
a customized account processing engine for facilitating the full payment of health care expenses in a single transaction, the customized account processing engine including:
a file preprocessing application for receiving an adjudicated claim for payment;
a business rules engine containing predetermined business rules governing the payment of both a consumer responsible amount and an insurance company responsible amount;
a file validation application for validating a request for payment of the adjudicated claim; and
a consumer decisioning application for causing full payment of the adjudicated amount to be directed to a health care provider and for generating a request for reimbursement for any consumer responsible amount.

12. The system according to claim 11, wherein the adjudicated claim conforms to the US Federal Health Insurance Portability and Accountability Act (HIPA) guidelines.
